(19) United States
(12) Patent Application Publication
(10) Pub. No.: US 2009/0277848 A1
(43) Pub. Date: Nov. 12, 2009

(54) Water recycling apparatus and method

(76) Inventors: David A. Slade, North Dandenong (AU); Anthony P. Marchmont, Mt. Eliza (AU); Roland V. Burgers, Mornington (AU)

Correspondence Address: TRASKBRITT, P.C., P.O. BOX 2550, SALT LAKE CITY, UT, 84110, US

(21) Appl. No.: 12/151,454

(22) Filed: May 6, 2008

(51) Int. Cl. B01D 24/46

(52) U.S. Cl. 210/793; 210/141; 210/532.1; 210/411; 210/275

(57) ABSTRACT

A water recycling tank 40 for a filtration system 10 including a filter 30 and pump 20, the tank: (a) in communication with the filter and the pump; (b) that has a substantial height difference between the upper internal space and the lower internal space of the tank whereby the tank is adapted to permit water-borne sediments 47 to settle near the base 52 of the tank over time; (c) has a waste outlet 44 near or on the base; (d) has a recycling outlet 43 above the waste outlet and in communication with the pump; and (e) has an inlet 42 above the recycling outlet in communication with the filter.

### FIELD OF INVENTION

This invention relates to a water recycling apparatus and method. More particularly, this invention relates to a water tank for a filtration system including a filter and pump, a water recycling arrangement incorporating a water recycling tank, and a water recycling method therefor.

### BACKGROUND ART

The following references to and descriptions of prior proposals or products are not intended to be, and are not to be construed as, statements or admissions of common general knowledge in the art. In particular, the following prior art discussion does not relate to what is commonly or well known by the person skilled in the art, but assists in the understanding of the inventive step of the invention of which the identification of pertinent prior art proposals is but one part.

The advent of drier climatic conditions caused by lower average rainfalls and higher average temperatures has emphasized the need for devices, methods and strategies for conserving water resources on all levels of society, including domestic, agricultural, industrial, and commercial.

Water filtration systems, by their very nature, accumulate filtered material, such as water-borne solids, vegetation, insects, hair, and the like. To clean the filter medium, one can remove same from the filter body for cleaning and replacement, or the filtration mechanism may be reversed by backwashing water through the filter against the prevailing or normal direction of water flow to dislodge the filtered material. Such water-borne filtered material is generally disposed to waste or storm water. In a standard sized sand filter used for a domestic pool, a typical backwash volume of water is about 1,500 liters. This represents a substantial waste of clean pool water. The accumulative waste of useable, if not potable, water on a community scale represents a massive loss of precious water resources, particularly if one considers the enormous volumes of water used to backwash community pools, domestic pools and spas and commercial and industrial cooling plants.

### DISCLOSURE OF THE INVENTION

In one aspect, provided is a water recycling arrangement for a filtration system including a filter and pump, the arrangement including a large water tank:
(a) in communication with the filter and the pump;
(b) that has a substantial height difference between the upper internal space and the lower internal space of the tank, whereby the tank is adapted to permit water-borne sediments to settle near the base of the tank over time;
(c) has a waste outlet near or on the base;
(d) has a recycling outlet above the waste outlet and in communication with the pump; and
(e) has an inlet above the recycling outlet in communication with the filter.

In another aspect, there is provided a water recycling tank for a filtration system including a filter and pump, the tank:
(a) in communication with the filter and the pump;
(b) that has a substantial height difference between the upper internal space and the lower internal space of the tank, whereby the tank is adapted to permit water-borne sediments to settle near the base of the tank over time;
(c) has a waste outlet near or on the base;
(d) has a recycling outlet above the waste outlet and in communication with the pump; and
(e) has an inlet above the recycling outlet in communication with the filter.

In still another aspect of the invention, there is provided a water recycling method for a filtration system including a filter, pump and settling tank, the method including the steps of:
(a) directing water from a reservoir through the filter to perform a backwash;
(b) directing the backwashed water from the filter through a recycling inlet line to the tank;
(c) allowing water-borne sediments to settle on or near the base of the tank;
(d) directing water above the settled sediment from the tank through a recycling outlet line to the reservoir; and
(e) periodically exhausting the sediment-laden water near the base through a waste outlet.

The person skilled in the art will appreciate that the word “communication,” in the context of a water pipe linking either the tank, filter, pump, or reservoir, includes a pipe having an in-line valve intermediate the aforementioned devices or installations.

The term “reservoir” refers to any water storage facility, tank or vessel subject to filtration and from which backwash water is drawn to periodically clean a filter. Examples of a reservoir include domestic and municipal pools, spas, cooling towers and drinking water storage facilities.

The term “phase boundary,” as used herein, refers to a region or layer of water between different regions within the same body of water that separates a relatively clear region of water from a region of water bearing a relatively high concentration of water-borne sediments, debris and the like, typically near the base of the settling tank.

### BRIEF DESCRIPTION OF THE DRAWINGS

Preferred features of the invention will now be described with particular reference to the accompanying drawings. However, it is to be understood that the features illustrated in and described with reference to the drawings are not to be construed as limiting on the scope of the invention. In the drawings:

FIG. 1 is a schematic view a water recycling arrangement according to a first embodiment of the invention;

FIG. 2 is a schematic view of the first embodiment showing the direction of water flow during a backwash procedure;

FIG. 3 is a schematic representation of the first embodiment showing the direction of water flow during a recycling procedure;

FIG. 4 is a schematic representation of a second embodiment of the invention;

FIG. 5 is a schematic representation of the return line from the tank to the pool according to the second embodiment;

FIG. 6 is a schematic representation of an alternative return line according to a third embodiment; and

FIG. 7 is a schematic representation of the tank of the first or second embodiments shown in more detail.

### DETAILED DESCRIPTION OF THE INVENTION

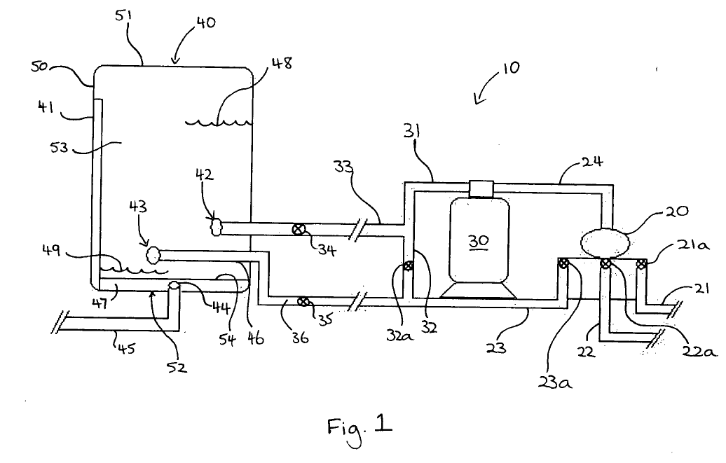

Referring to FIGS. 1 through 3, shown is a water recycling arrangement 10 comprising a pump 20, filter 30, and settling tank 40.

The tank 40 is provided in any suitable form and may be made from a range of suitable materials. For example, the tank 40 may be a standard cylindrical shape or may be shaped to better conform to its surroundings, particularly where space is at a premium. For example, the tank 40 may be shaped to fit along a building wall profiled to minimize interruption to pedestrian traffic or other uses of the surrounding space. The tank 40 is made from standard tank-forming materials, such as galvanized iron, and more preferably is made from a plastic material such as polycarbonate, polyethylene, polypropylene and the like. The tank 40 is preferably rota-molded to enable the shaping of the tank 40 to suit restricted or unusually shaped spaces. However, the tank 40 may be molded by other means, such as blow-molding.

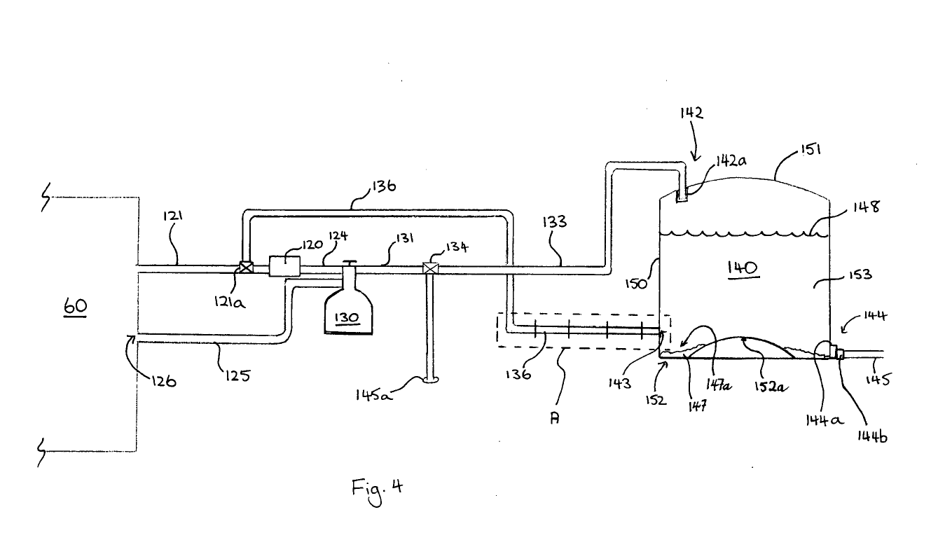

The tank 40 capacity will generally correspond to the capacity of the reservoir and/or the filter 30. The reservoir shown in the drawings is a pool 60 (see FIG. 4). As an example, where the pool 60 is a typical domestic pool containing 40,000 liters of water, the arrangement 10 will require a settling tank 40 having a capacity of 4,000 liters. Where the reservoir is a domestic spa having a capacity of 6,000 liters, the arrangement 10 will require a settling tank capacity of about 600 liters. Where the tank 40 is relatively small in capacity (for example, 500-2,000 liters), advantageously, the tank 40 will be vertically elongate to give water-borne solid materials sufficient distance along a substantial vertical length to settle under the influence of gravity over time.

This settling process has the affect of achieving a separation of clean, reusable water comprising the 80 to 90% uppermost portion of the water in the tank 40 on completion of the settlement process. The remaining lowermost 10 to 20% portion of the contents at the base 52 of the tank 40 may be composed of sediment and slime associated with the disposable product of water filtered by the arrangement 10. If left unaided, water-borne solid particles will tend to settle by the influence of gravity at the base 52 of the body of water in the tank 40 in order to achieve distinct clean water and sedimentary or colloidal phases over a period of about two to three days. Even very fine particles of silt will tend to migrate to the base 52 despite the presence of micro currents and movement occasioned by temperature variations across the length of the tank 40 and bumps and vibrations that the tank 40 may be exposed to, depending on its location.

The tank includes a recycling inlet 42 that is positioned to deliver backwash water into the tank 40 at an upper portion of the tank 40 and at least at a height from between 25 and 95% of the height of the tank 40 taken from its base 52. The lower the capacity of the pump 20 to force water against pressure, the higher up the tank 40 wall the recycling inlet 42 should be. The reason for this is that as the tank 40 fills with backwash water, the water pressure in the lower regions of the tank 40 increases, and further water must be pressurized to be forced into the tank 40 once the water rises above the recycling inlet 42. The recycling inlet 42 may be positioned uppermost in or through the wall 50 of the tank 40, and most preferably in or through the roof or lid 51 of the tank 40 (as shown in FIG. 4), to minimize pressure resistance that might otherwise lead to back-flow pressure in a filter-tank line 31, 33 joining the filter 30 to the tank 40. Advantageously, a selectively directional check valve 34 is placed in line in the recycling inlet line to prevent backwash flowing back towards the filter 30 from the tank 40.

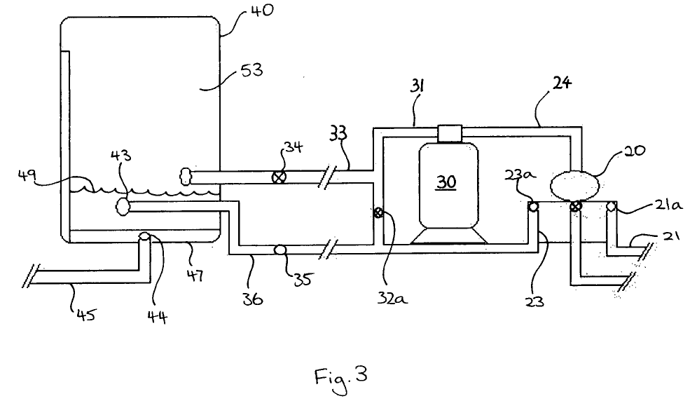

The tank 40 has a recycling outlet 43 that is preferably positioned just above the phase boundary of the sediment/water zone 47 near the base 52 of the tank 40. This may ensure that, at the completion of the settling process, the water drawn through the recycling outlet 43 is substantially clean water to be returned through a recycled water return line 36 to the reservoir 60 optionally via the filter 30 and/or the pump 20. To minimize turbulence at the base 52 while water is being drawn into the recycling outlet 43, baffles (not shown) in the base 52 may be provided. Furthermore, the recycling outlet 43 may extend into the tank 40 by a recycling outlet arm 43a extending through the tank wall 50. The recycling outlet arm 43a may include a flexible joint or portion close to the tank wall 50 or may be composed substantially of a flexible material, such as rubber hose. By a combination of weights and/or floats and taking into account the buoyancy of the recycling outlet arm 43a, the recycling outlet 43 may be positioned just under the upper water surface 49 (see FIG. 3) in the tank 40 to minimize turbulence at the base 52 as water is drawn into the recycling outlet 43. However, in a preferred form, the recycling outlet 43 is in a fixed position located near the base 52 in the wall 50 just above the upper surface of the sediment phase 47. The recycling outlet 43 may further include downwardly depending rigid arms adapted to space the outlet 43 from the tank base 52 to ensure that water from the sediment phase 47 is not drawn into the outlet 43 and that only substantially clean water is drawn into the outlet 43.

The tank 40 has a waste outlet 44 that is preferably located at or near the base 52 and below the upper surface of the phase boundary between the sedimentary phase 47 and the clean water phase 53. The arrangement includes a tank-waste line 45 that, for example, is adapted to deliver the sediment water phase 47, either to garden beds for recycled use or to a storm water drain for disposal as waste.

With reference to FIG. 4, the tank 140 may include an internally convex base 152 having a centrally raised floor 152a similar in shape to the base of a wine bottle. In this arrangement, the waste outlet 144 may be located at the lower side edge of the tank 140 where the wall 150 and base 152 meet. Further details of this arrangement are described in more detail hereafter. The corollary of this arrangement is an arrangement in which the base 152 is internally concave and the waste outlet 144 is in such cases centrally located in the base 152 because the sediment 147 will tend to collect centrally on the internal surface of base 152.

With regard to use of the waste water as water for the garden, it is noted that chemicals used in the treatment of water in the tank 40, for example, where the reservoir 60 is a pool, will generally dissipate by evaporation or chemical breakdown over a period of two to three months. In such cases, it is believed that there are no more than trace amounts of such chemicals in the sediment-containing water 47 at the completion of a settling period. For example, chlorine gas will generally be given off into the atmosphere and salt in solution will remain in generally low and non-harmful concentrations. In any case, care may be taken to deliver such waste water 47 only to selected plant types that are known to be salt resistant or tolerant.

By the above-described method, through each two- to three-month cycle, between 80 to 90% of backwash water can be recycled by returning it to the reservoir 60 and the remaining 10 to 20% of sediment phase water 47 can potentially be reused, for example, on plants and gardens. Accordingly, the amount of replacement water required to top-up the reservoir 60 over time can be substantially reduced leading to substantial savings in water use.

The preferred forms of the invention will now be described with greater particularity. In the first embodiment, the pump 20 shown in FIGS. 1 through 3 is a standard fixture for a typical domestic pool (not shown) having a capacity of between 20,000 and 40,000 liters. The pump can selectively direct water flow through one or more of four pipe lines: a pump-pool line 21, a pump-solar heating line 22, a pump-tank line 23 and a pump-filter line 24. The pump-pool line 21 is selectively opened and closed by the operation of the first valve 21a, the pump-solar heating line 22 is governed by a second valve 22a and the pump-tank line 23 is governed by a third valve 23a. In turn, the first, second and third valves 21a, 22a, 23a are governed by a control device, such as a simple computer processor typically used to control the operation of modern pool pumps. Alternatively, the selection of one line 21, 22, 23 can be manually controlled by a lever-operated manual valve, commonly used in pool filters.

The pump-filter line 24 communicates the pump 20 with the filter 30. The filter 30 is a standard sand filter, although other suitable filter types known in the art are within the scope of this invention. For example, activated carbon or charcoal filters as well as various synthetic filter media can also be cleaned by backwashing. The pump-filter line 24 terminates at the filter 30. Extending between the filter 30 and the tank 40 is a filter-tank line 31, 33 made up of a first section 31 and a second section 33. Extending between the filter-tank line 31, 33 and the pump-tank line 23 is an intermediate line 32. The intermediate line 32 includes an in-line intermediate valve 32a. The second section of the filter-tank line 33 includes an inline backwash valve 34. The section of pump-tank line 23 between the intermediate line 32 and the tank 40 may be described as a recycled water return line 36. The recycled water return line 36 includes an inline recycled water valve 35.

The tank 40 is preferably a rotary molded polypropylene hollow cylindrical body including a transparent viewing window 41 (for example, made of Perspex™) inserted in its, or one of its, vertical walls 50. Alternatively, the viewing window may be in the form of a sight tube spaced from the vertical wall 50. The viewing window 41 permits an operator to assess the water level 48, 49 at a quick glance. The tank 40, 140, 240 (referring to other embodiments of the invention) may be provided without a sight tube or glass where algal growth may present a problem. In this regard, where light is able to penetrate into the tank internal space, algal growth may be stimulated and this will generally be undesirable. However, where clean water 53 is to be frequently released from the tank 40 or the water 53 treated to prevent algal growth, a sight tube 41 may be desirable to enable easy assessment of the tank's 40 water level 48.

The tank 40 is covered with a lid 51 to limit evaporative loss and to reduce contamination from animal feces and the ingress of decomposing vegetation such as leaves. The lid 51 may be removable to allow inspections, repairs and maintenance operations to be performed internally in the tank 40.

At the base of the tank 40, the backwashed water will contain a certain amount of sediment. After settling, this will be found in a lowermost sediment phase 47 in the 10 to 20% lowermost portion of the tank 40. The waste outlet 44 is placed in the base 52 of the tank 40. The base 52 is preferably marginally internally concave and the waste outlet 44 is preferably located central to the base 52 to most effectively periodically drain the sediment phase 47 through the waste outlet 44 as will be described in detail below.

The recycled water return line 36 terminates in the tank 40 in a recycling outlet 43. The recycled water return line 36 extends through the vertical wall 50 through a water-tight seal, such as an annular seal where cylindrical pipe is used for the recycled water return line 36. The internal length of the recycled water return line 36 may be flexible and may include floats to allow the recycling outlet 43 to rise and lower with the corresponding rising and lowering of the tank 40 water level 48, 49 to minimize the turbulence created near the base 52 by the drawing of water from the clean water phase 53. The clean water phase 53 describes water found above the phase boundary 54 separating the sediment phase 47 from the clean water phase 53.

The tank 40 includes a recycling inlet 42, which is the terminal end of the second section of the filter-tank line 33. The recycling inlet 42 may be positioned uppermost in the vertical wall 50, although, for practical purposes, the recycling inlet 42 may be positioned anywhere intermediate the vertical length of the vertical wall 50 as the pump 20 will provide sufficient positive pressure to ensure that backwash water can be forced into the tank 40 under pressure sufficient to fill the tank 40 to its capacity. In any case, unidirectional valve 34 will prevent backflow.

In FIG. 1, the water level 48 represents the high water level achieved when the tank 40 is filled to capacity and the water level 49 represents the low water level achieved after the upper portion of water in the tank 40 is returned to the filter 30/pump 20/reservoir at the end of a settling period of between two to three days. It will be noted that the low water level 49 is above the phase boundary 54 whereby only substantially clean water from the clean water phase 53 is recovered from the tank 40 for reuse in the reservoir (not shown).

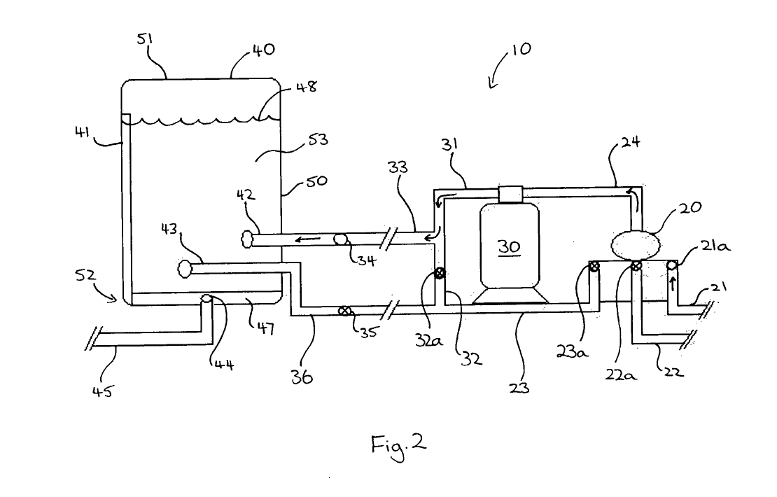

Referring to FIG. 2, the configuration of the arrangement 10 is shown with regard to the operation of valves 21a, 22a, 23a, 32a, 34. To achieve a backwash cleaning operation of the filter 30, water is drawn from the pool through the pump-pool line 21 and through the pump 20 via the open valve 21a. Note that the second and third valves 22a, 23a are closed whereby water is directed into the pump-filter line 24 through the filter 30 to affect a backwash thereof. The water flow continues into the filter-tank line 31. The water is prevented from flowing into the intermediate line 32 by the closed fourth valve 32a, so that water is forced into the second section of the filter-tank line 33 where the inline backwash valve 34 permits the water to continue under force of the pump 20 into the tank 40 through the recycling inlet 42. The backwash operation is continued until the water level in the tank reaches the top water level 48. The operator can monitor the rising water level 48 by viewing through the window 41. It will be appreciated that the viewing window 41 may be substituted with any suitable functional equivalent, such as an external water level indicator tube in communication with the tank 40 through an aperture in the vertical wall 50 near the base 52, but above the phase boundary 54.

The backwashed water residing in the tank 40 may be left to settle for two to three days so that sediments and other water-borne solids in the backwashed water 53 migrate to the base 52 over time to form a sediment phase 47.

At the end of the settling period, an operator may activate the recycling procedure represented in FIG. 3. The backwash procedure and the recycling procedure may be advantageously controlled by a computer processor adapted to control the opening and closing of the valves 21a, 22a, 23a, 32a, 34, 36. In FIG. 3, the fifth valve 35 is open, the fourth valve 32 is closed, the third valve 23a is open and the first valve 21 a is open whereby the pump 20 is used to draw clean water 53 from the tank 40 through the recycling outlet 43 into the recycled water return line 36, through the pump 20 and returned to the pool via the pump-pool line. This operation continues until the tank 40 water level is lowered to the low water level 49. To ensure that water does not enter the lines 36, 23, 21, the minimum level that the clean water 53 can be reduced to is the lower level 49 just above the uppermost portion of the recycling outlet 43. By this process, the backwash water is recovered as clean water 53 returned to the pool after the settling period.

The remaining sediment phase 47 may be passively or actively drained from the tank 40 through the waste outlet 44, into the waste pipe 45 whereby it may be delivered into the garden for recycled horticultural use or otherwise disposed of down a storm water drain or otherwise disposed of, for example, where local regulations impose restrictions on how such waste may be disposed of.

In FIG. 4, there is shown a backwash recycle system 110 using an existing swimming pool filtration system, the system 110 comprising a pump 120, sand filter 130, and settling tank 140.

The tank 140 is similar to that shown in relation to the first embodiment and like features are indicated by like reference numerals plus 100. The base 152 is internally convex and includes a centrally raised internal floor forming a hemispherical-shaped mound 152a similar to a base of a wine bottle. As a consequence, during settlement, sediment 147 is dispersed from the center and pooled at the edges of the lower internal spaces of the tank 140 around the periphery of the base 152. At the base 152 there is located a drain portal 144 in the wall 150 from which extends a drain pipe 145. The drain portal 144 is preferably flush with the floor of the base 152 for more thorough drainage and has a poly threaded nipple 144a extending through the portal 144 and threadably connecting the tank 140 to the drain pipe 145. As a check valve, the drain portal further includes a nylon ball valve 144b. Sediment 147 tends to collect around the periphery of the base 152 and, on opening the waste outlet or drain portal 144, may be drained from the tank 140 as it follows the course of the annular channel 147a formed between the base 152, the mound 152a and the wall 150.

The recycling outlet 143 is connected to a backwash storage tank return line 136 that connects to a pump-pool line 121 using a PVC three-way ball valve 121a to control the junction of lines 121, 136.

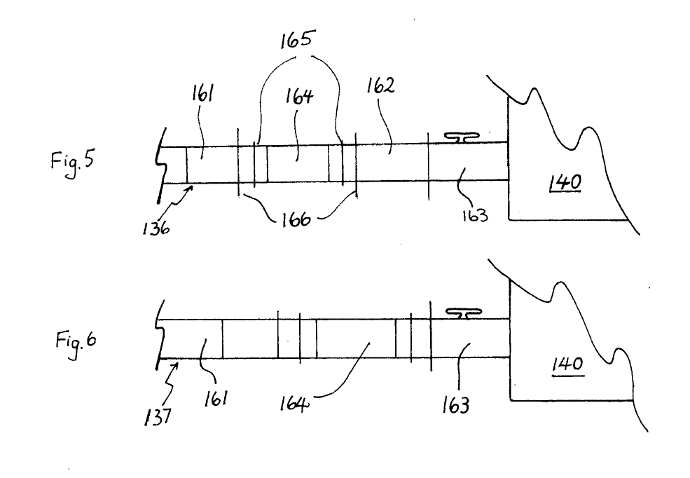

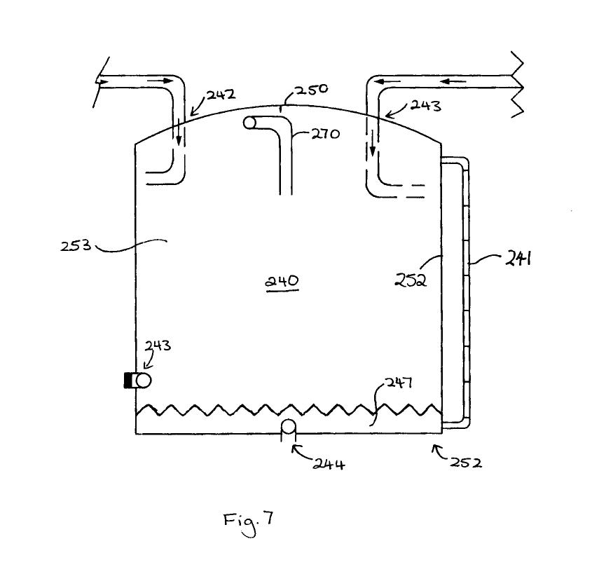

The section A shown in FIG. 4 may be in the form of two alternative arrangements shown in FIGS. 5 and 6.

The tank inlet 142 comprises a PVC (polyvinylchloride) valve socket 142a through which backwash water is pumped into the storage tank 140 via a second section of a filter tank line 133. A first section of the filter tank line 131 extends the filter tank line 131, 133 to the sand filter 130. At the junction between the first and second sections of the filter tank line 131, 133 is a PVC three-way ball valve 134 connecting the filter tank line 131, 133 to a waste outlet 145a, such as sewerage or storm water. The valves 121 a and 134 may be controlled by computer programming operating a computer processor unit controlling the system 110, or may be manually manipulated by an operator.

Interposed between the filter 130 and the pump 120 is a pump filter line 124. A valve junction in the form of a three-way ball valve 121 a provides a junction between the return line 136 and a pump-pool line 121. The system is completed by a filter-pool line 125 terminating at the pool end in a pool return outlet 126.

Turning to FIG. 5, there is shown an exploded view of the backwash storage tank return line 136 for installations where the tank recycled water outlet 143 is oriented below the horizontal line of the existing filtration system 130. The pipe section 136 includes an inline PVC faucet 161 at a plastic non-return valve 162 and a nylon ball valve 163. Interposed between the non-return valve 162 and the faucet socket 161 is a section of flexible hose or pipe 164 secured in line in the return line 136 by a combination of poly hose barbs 165 and stainless steel hose clamps 166. The non-return valve 162 is required to prevent backflow of water under gravity feed from the filter 130 back into the storage tank 140 through the recycled water outlet 143.

In a slightly different embodiment to that shown in FIG. 5, in FIG. 6 there is shown an alternative return line section 137 for installations where the water outlet 143 is located above the horizontal line of the filter 130 so that backflow from the filter 130 to the tank 140 is not an issue. In this arrangement, the alternative return line 137 is similar to the return line 136 shown in FIG. 5, but the non-return valve 162 maybe omitted.

To install the above-described arrangement 110, the following procedure may be followed:
1. Install the PVC three-way ball valve 121 a into an existing pool suction line 121 in front of an existing pool pump 120;
2. Install a PVC three-way ball valve 134 into the filter-tank line 131, 133;
3. Connect the filter-tank line to the top or roof 151 of the storage tank 140 and connect a PVC valve socket 142a to the tank inlet 142. The PVC valve socket 142a can be placed into either a threaded tank inlet 142 or a rubber or plastic bung may be used to secure the valve socket 142a in the tank inlet 142.
4. Connect the backwash storage tank return line 136, with appropriate fittings 161-166 to the three-way ball valve 121 a in the pump-pool line 121, noting that the arrangement of FIG. 5 or that of FIG. 6 for return line 137 should be used depending on whether the water outlet 143 is above or below the line of the filter 130; and
5. Connect the waste fittings 144a, 144b and 145 to the drain portal 144 of the tank 140.

During installation of the storage tank 140, the following should be noted:
1. The tank 140 site must be flat, level and smooth. Concrete, compacted sand or similar fill is ideal. Sand or fill must be boxed to prevent washing away. The prepared area requires that there be a centrally located mound of sand, not necessarily matching the indentation of the base 152 precisely, but ensuring that a certain amount of mounded sand is provided supporting the indentation of the tank base 152. It should be ensured that the outside perimeter of the tank 140 is also on a level surface.

With regard to operating instructions, the following procedures should be observed:
1. Ensure that all filters 130 and pumps 120 are switched off;
2. Open the three-way ball valve 134 ensuring that the line leading to the waste outlet 145a is closed. It should be noted that this three-way valve 134 may remain open for further water transfer to the tank 140.
3. Follow the manufacturer's instructions regarding backwash or waste procedures.

With regard to the operation of the return of clean water 153 to the swimming pool 60, the following operating procedures should be observed:
1. Ensure that the filter 130 and pump 120 are switched off.
2. Ensure that the ball valve 163 is open (refer to FIGS. 5 and 6).
3. Open the three-way ball valve 121a to ensure that the return line 136, 137 is open and the pump-pool line 121 is closed.
4. Start the normal filtration cycle using the filter 130 so that clean water 153 will return from the tank 140 to the swimming pool 60 via the filter 130.
5. Once the required levels have been established in the pool 60 or the clean water 153 in the storage tank 140 has been exhausted, turn the filtration system 130 off.
6. Close the three-way ball valve 121 a ensuring that the return line 136 is closed and the pump-pool line 121 is open. It is important that this step is carried out correctly and that the three way ball valve 121 a is closed properly as it is possible that water may be drawn from the tank 140 on the normal filtration cycle even if open slightly, and in cases where settlement of the water in the tank 140 is not yet completed, this may be undesirable.

With reference to FIG. 7, there is shown a tank 240 that may be used in any one of the above-described embodiments. The tank 240 is rotary molded and all fittings are plastic as pool salt and chemicals will corrode components made, for example, of brass. The tank 240 includes an inlet 242 from the filter and an outlet 143 connecting the tank 240 back to the pool. The base 252 of the tank includes a centrally located waste outlet 144. As an option, the tank 240 may include an optional rain water inlet 243 located in the roof 250. The rain water inlet 243 may be connected to storm water run off from a domestic dwelling. The tank 240 may include a sight glass 241 attached to the wall 252 of the tank 240. An overflow outlet 270 located uppermost in the tank 240 may be provided to connect the primary storage tank 240 to secondary storage tanks (not shown) or to waste. It should be noted that the clean water 253, even following settlement, will not normally be suitable for drinking, unless further treated.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the lid 51 uppermost.

What is claimed is:

1. A water recycling arrangement for a filtration system including a filter and pump, said arrangement including a large water tank for receiving backwashed water having water-borne particles, wherein said tank:
(a) is in communication with said filter and said pump;
(b) has a substantial height difference between the upper internal space and the lower internal space of said tank whereby said tank is adapted to permit water-borne particles to settle near the base of said tank over time to obtain a substantially clear water phase above the settled sediments;
(c) has a waste outlet near, in or on said base;
(d) has a recycling outlet above said waste outlet through which clear water from the clear water phase may be periodically released; and
(e) has an inlet above said recycling outlet, said inlet for receiving said backwashed water.

2. The water recycling arrangement of claim 1, wherein said tank is adapted to permit water-borne sediments to settle in the lower 20% of its internal volume.

3. The water recycling arrangement of claim 2, wherein said inlet is positioned above said lower 20% of said tank's internal volume.

4. The water recycling arrangement of claim 1, wherein said arrangement further includes at least one inline valve in the line communicating the filter to the tank that is controlled by a computer processor.

5. A water recycling tank for a filtration system including a filter and pump, wherein said tank:
(a) is in communication with said filter and said pump;
(b) has a substantial height difference between the upper internal space and the lower internal space of said tank whereby said tank is adapted to permit water-borne particles to settle near the base of said tank over time to obtain a substantially clear water phase above the settled sediments;
(c) has a waste outlet near, in or on said base;
(d) has a recycling outlet above said waste outlet and in communication with a water reservoir; and
(e) has an inlet for receiving backwashed water from said water reservoir, said inlet located above said recycling outlet, and
wherein said clear water phase can be periodically released through said recycling outlet to said water reservoir to replenish water level in said water reservoir.

6. The water recycling tank of claim 5, wherein the height of said tank is at least 300 mm.

7. The water recycling tank of claim 5, wherein the capacity of said tank is at least 500 L.

8. The water recycling tank of claim 5, wherein said tank is substantially cylindrical.

9. The water recycling tank of claim 5, wherein said tank base is internally concave to collect sediment towards the center of said base and said waste outlet is located centrally in said base.

10. The water recycling tank of claim 5, wherein said tank base is internally convex to disperse sediment towards the periphery of said lower internal space.

11. The water recycling tank of claim 9, wherein said waste outlet is located lowermost in the water recycling tank in a side wall of the water recycling tank.

12. The water recycling tank of claim 5, wherein said recycling outlet is positioned above the settled sediment.

13. The water recycling tank of claim 5, wherein said recycling outlet is the terminal end of a flexible hose that is weighted and/or floated to sit just under the upper water surface level in said tank.

14. A water recycling method for a filtration system that includes a filter, pump, and settling tank, said method comprising:
(a) directing water from a reservoir through said filter to perform a backwash;
(b) directing the backwashed water from said filter through a recycling inlet line to said tank;
(c) allowing water-borne sediments to settle on or near the base of the tank;
(d) directing water above said settled sediment from said tank through a recycling outlet line to said reservoir; and
(e) periodically exhausting said sediment-laden water near said base through a waste outlet.

15. The method of claim 13, wherein said sediment-laden water is reused for horticultural purposes.

16. A water recycling arrangement for a filtration system including a filter and pump, said arrangement including a large water tank:
(a) in communication with said filter and said pump;
(b) that has a substantial height difference between the upper internal space and the lower internal space of said tank whereby said tank is adapted to permit water-borne particles to settle near the base of said tank over time to obtain a substantially clear water phase above the settled sediments;
(c) has a waste outlet near, in or on said base;
(d) has a recycling outlet above said waste outlet and in communication with a water reservoir; and
(e) has an inlet for receiving backwashed water from said water reservoir, said inlet located above said recycling outlet,
wherein said clear water phase can be periodically released through said recycling outlet to said water reservoir to replenish the water level in said water reservoir.
